(19) United States
(12) Patent Application Publication
(10) Pub. No.: US 2025/0337184 A1
(43) Pub. Date: Oct. 30, 2025

(54) HIGH POWER DIRECT-CURRENT CHARGING SOCKET CONNECTOR AND PLUG CONNECTOR

(71) Applicant: ACES ELECTRONICS CO., LTD., Taoyuan City (TW)

(72) Inventors: Rong-Hsun KUO, Taoyuan City (TW); Kuei-Ta HSIEH, Taoyuan City (TW)

(21) Appl. No.: 19/030,364

(22) Filed: Jan. 17, 2025

(30) Foreign Application Priority Data
Apr. 25, 2024 (TW) 113204194

(51) Int. Cl. H01R 13/424; H01R 13/05; H01R 13/11

(52) U.S. Cl. CPC H01R 13/424; H01R 13/055; H01R 13/112; H01R 13/113

(57) ABSTRACT

A high power direct-current (DC) charging socket connector and a DC charging plug connector, each of one the DC charging socket and plug connectors has two pair of power electrode boards arranged on the upper and lower rows of a corresponding one of the connectors. The electrode boards on the upper row have only a single one positive board and a single one negative board. The electrode boards on the lower row have only a single one positive board and a single one negative board and are arranged alternatively with the single one positive board and the single one negative board on the upper row. Thus, the DC charging socket and plug connectors can support reverse insertion. Therefore, the width of each board can be as large as possible with the connector size standards to increase the withstand current value to achieve the high power charging effect.

### CROSS-REFERENCE TO RELATED APPLICATIONS

This application is based upon and claims priority under 35 U.S.C. 119 from Taiwan Patent Application No. 113204194 filed on Apr. 25, 2024, which is hereby specifically incorporated herein by this reference thereto.

### BACKGROUND OF THE INVENTION

### 1. Field of the Invention

The present invention relates to a charging connector, and more particularly to a high power direct-current socket connector and plug connector.

### 2. Description of the Prior Arts

With the trend of thin and light design of electronic products, a size of a direct-current (DC) charging connector applied for an electronic product has been reduced. Because the electronic product is frequently used and has high power consumption, great charging is required to meet the demand for rapidly charging.

Therefore, the following table shows a table of summary of power supply options for a small sized USB DC charging connector. The conventional maximum current is only up to 5 A (amperes), so further improvement is necessary.

| Mode of | Nominal | Maximum | | |
|---|---|---|---|---|
| Operation | Voltage | Current | | Notes |
| USB 2.0 | 5 V | 500 | mA | Default current, based |
| USB 3.1 | 5 V | 900 | mA | on definitions in the |
| | | | | based specification |
| USB BC 1.2 | 5 V | Up to 1.5 A | | Lengacy charging |
| USB Type-C | 5 V | 1.5 | A | Supports higher power |
| Current @ | | | | devices |
| 1.5 A | | | | |
| USB Type-C | 5 V | 3 | A | Supports higher power |

| | | | |
|---|---|---|---|
| Current @ | | | devices |
| 3.0 A | | | |
| USB PD | Configurable | Configurable | Directional control and |
| | up to 20 V | up to 5 A | power level management |

To overcome the shortcomings, the present invention provides a high power DC charging socket connector and a plug connector to mitigate or to obviate the aforementioned problems.

### SUMMARY

An objective of the present invention is to provide a high power DC charging socket connector and a plug connector.

The high power DC charging socket connector has:
a first housing;
an insulation tongue mounted in the first housing and has a first surface and a second surface opposite to each other;
a single first positive board mounted on the first surface of the insulation tongue;
a single first negative board mounted on the first surface of the insulation tongue and arranged with the first positive board side by side;
a single second positive board mounted on the second surface of the insulation tongue and located alternatively below the first negative board; and
a single second positive board mounted on the second surface of the insulation tongue and located alternatively below the first positive board.

Based on the foregoing description, to achieve the high power charging effect, a maximum current of the high power DC charging socket connector has to be increased. Therefore, a single positive board and a single negative board are mounted on a first surface of an insulation tongue of the DC charging socket connector. The widths of the single first positive board and the single first negative plate can be as large as possible within the connector size standards. A second positive board and a second negative board mounted on a second surface of the insulation tongue are same as the first positive and negative boards. In addition, since the width of each of the first and second positive and negative boards is wide enough, compared with an electrical connector of the same size, the strength of the insulation tongue is increased and the service life of the DC charging socket connector is extended.

The high power DC charging plug connector has:
a third housing having a front opening and a rear opening;
an insulation bottom base mounted in the third housing and comprising an insertion recess having a first recess wall, a second recess wall, and a mouth facing the front opening in the third housing;
a single one first resilient positive board mounted on the insulation bottom base and having a resilient portion extending along the first recess wall of the insertion recess;
a single one first resilient negative board mounted on the insulation bottom bas, having a resilient portion extending along the first recess wall of the insertion recess, and arranged with the first resilient positive board side by side;
a single one second resilient positive board mounted on the insulation bottom base, having a resilient portion extending along the second recess wall of the insertion recess, located alternative below the first resilient positive board and below the first resilient negative board; and
a single one second resilient negative board mounted on the insulation bottom base, having a resilient portion extending along the second recess wall of the insertion recess, located alternatively below the first resilient negative board and below the first resilient positive board.

Based on the foregoing description, the high power DC charging plug connector has a single positive board, a single negative board, a second positive board and a second negative board. The widths of the four boards can be as large as possible within the connector size standards to match the four boards of the high power DC charging socket connector. The DC charging plug connector supports the forward and reverse insertion. Therefore, a maximum current of the high power DC plug socket connector is also increased to achieve the high power charging effect.

### BRIEF DESCRIPTION OF THE DRAWINGS

FIG. 1 is a perspective view of a high power DC charging socket connector in accordance with the present invention;

FIG. 2 is an exploded perspective view of the high power DC charging socket connector in FIG. 1;

FIG. 3 is a cross sectional front view of the high power DC charging socket connector in FIG. 1 connected with a plug connector in accordance with the present invention;

FIG. 4 is a cross sectional side view of the high power DC charging socket connector in FIG. 1 connected with a plug connector 3 in accordance with the present invention;

FIG. 5 is a perspective view of a high power DC charging plug connector in accordance with the present invention; and

FIG. 6 is a cross sectional side view of the high power DC charging plug connector in FIG. 5.

### DETAILED DESCRIPTION OF THE EMBODIMENTS

The present invention is related to an improved charging connector. Other objectives, advantages and novel features of the invention will become more apparent from the following detailed description when taken in conjunction with the accompanying drawings.

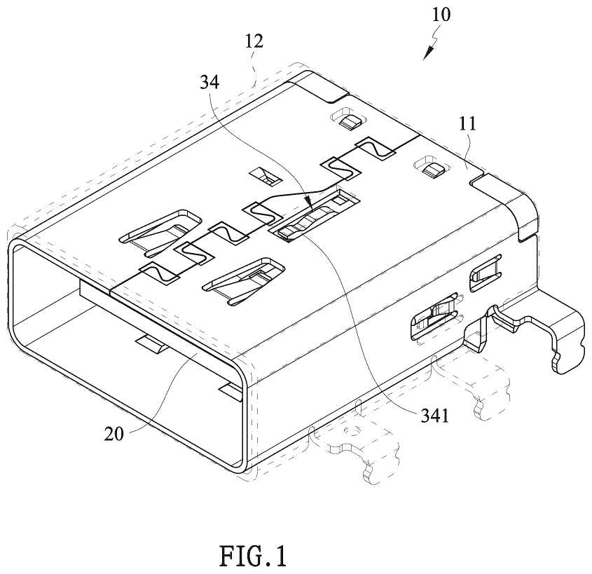

With reference to FIGS. 1 to 3, a high power direct-current (DC) charging socket connector 10 in accordance with the present invention comprises a first housing 11, an insulation tongue 20, a single one first positive board 30, a single one second positive board 32, a single one first negative board 31, and a single one second negative board 33.

The first housing 11 is a metal housing, and a second housing 12 can be further mounted around the first housing 11. The first housing 11 comprises a first through hole 111, a front opening 112, a rear opening 113. The second housing 12 comprises a second through hole 121 communicating with the first through hole 111 in the first housing 11.

The insulation tongue 20 is disposed in the first housing 11. In this embodiment, an insulation base 25 is formed integrally with a rear end of the insulation tongue 20 and held in the rear opening 113 in the first housing 11. In an embodiment, a spacer plate 26 is laterally embedded in the insulation tongue 20. The spacer plate 26 is a flat metal plate and has a minimum thickness of 0.15 mm. In another embodiment, two sides 261 of the spacer plate 26 are exposed from two opposite sides 23 of the insulation tongue 20. In a further embodiment, two sides 261 of the spacer plate 26 can be formed by two flat metal plates stacked with each other, so the thickness of the spacer plate 26 is twice of the thickness of the metal plate. In addition, a front end 262 of the spacer plate 26 may be bent to deform a non-flat shape. This means that it May be protruded or bent to make a highest height of front end 262 larger than the thickness of the spacer plate 26. Additionally, the front end 262 of the spacer plate 26 may partially or completely protrude out from a front end 24 of the insulation tongue 20.

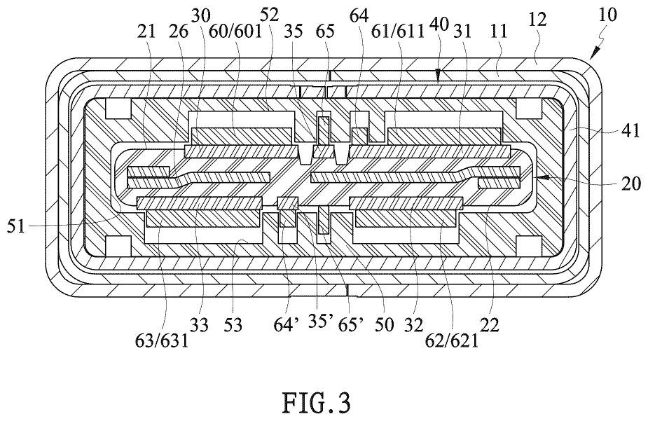

The first positive board 30 and the first negative board 31 are mounted securely side by side on a first surface 21 of the insulation tongue 20. With reference to FIG. 3, the second positive board 32 and the second negative board 33 are mounted securely side by side on a second surface 22 of the insulation tongue 20. Viewed from a direction of FIG. 3, the first positive board 30 and the second positive board 32 are respectively located on the first surface 21 and the second surface 22 of the insulation tongue 20 alternatively at left and right positions. The first negative board 31 and the second negative board 33 are respectively located on the first surface 21 and the second surface 22 of the insulation tongue 20 alternatively at right and left positions. Therefore, the second negative board 33 is located below the first positive board 30, and the second positive board 32 is located below the first negative board 31. In one embodiment, each one of the first positive board 30, the first negative board 31, the second positive board 32, and the second negative board 33 has a minimum thickness of 0.2 mm. A gap with a maximum distance of 0.2 mm is formed between each board 30, 31, 32, 33 and the most adjacent surface of the spacer plate 26. In addition, the thickness of each one of the first negative board 31 and the second negative board 33 is larger than the thickness of each one of the first positive board 30 and the second positive board 32.

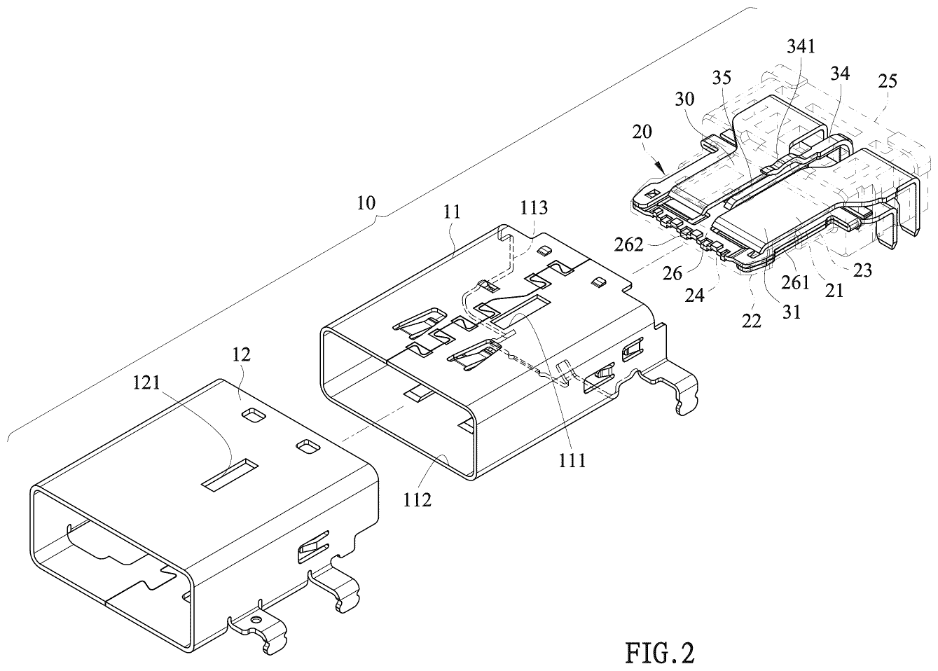

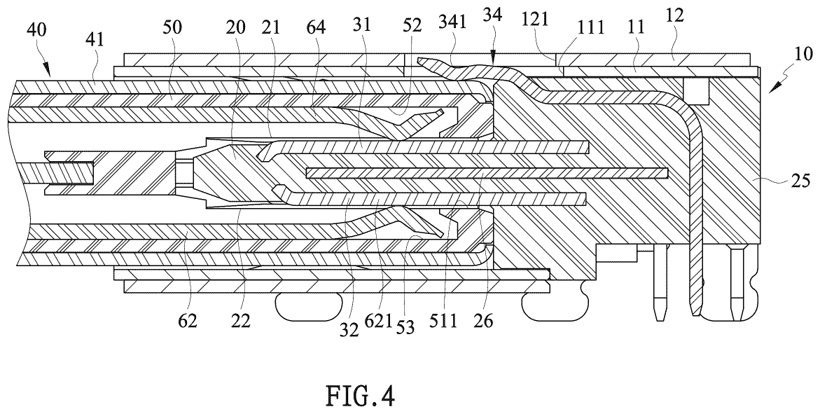

With reference to FIGS. 2 and 4, the DC charging socket connector in accordance with the present invention may further comprise a resilient terminal 34 and at least one signal terminal 35. The resilient terminal 34 is mounted securely in the insulation base 25 and has a front end protruding upward and exposed from a top surface of the insulation base 25 and extending through the first through hole 111 in the first housing 11 and into the second through hole in the second housing 12. A contact portion 341 is formed and bent from the front end of the resilient terminal 34 and is located in front of the insulation base 25 and above the first surface 21 of the insulation tongue 20. The at least one signal terminal 35 may be mounted on the first surface 21 or the second surface 22 of the insulation tongue 20. In one embodiment, with reference to FIG. 3, the DC charging socket connector comprises two first signal terminals 35, 35′ mounted respectively on the first surface 21 and the second surface 22 of the insulation tongue 20. The first signal terminal 35 mounted on the first surface 21 is located between the first positive board 30 and the first negative board 31, and the first signal terminal 35′ mounted on the second surface 22 is located between the second positive board 32 and the second negative board 33. A front end of each signal terminal 35, 35′ is away from the front ends of the first and second positive boards 30, 32 or the front ends of the first and second negative boards 31,33.

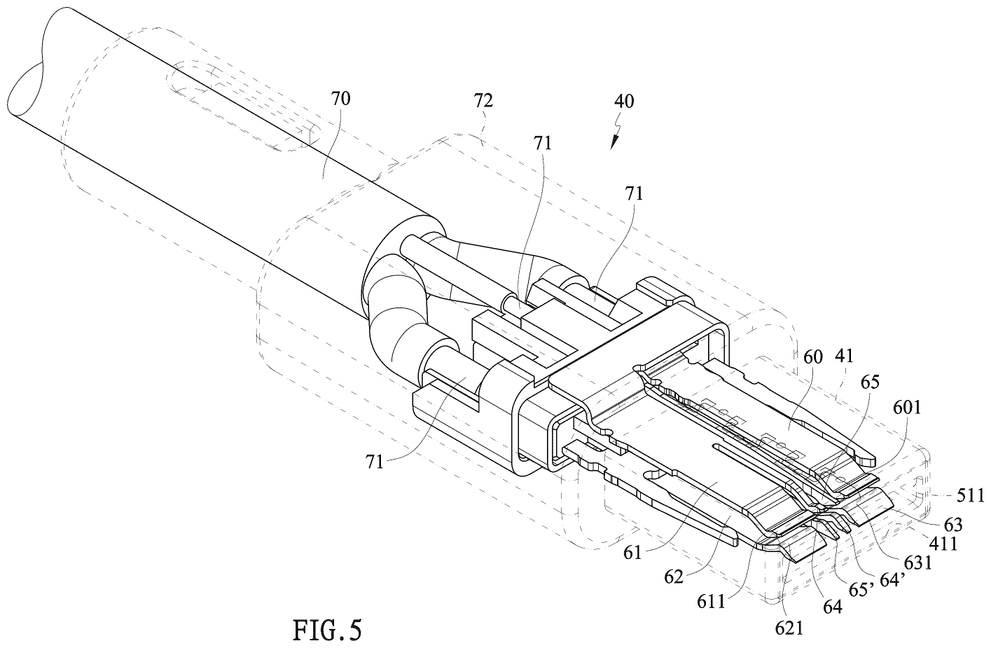

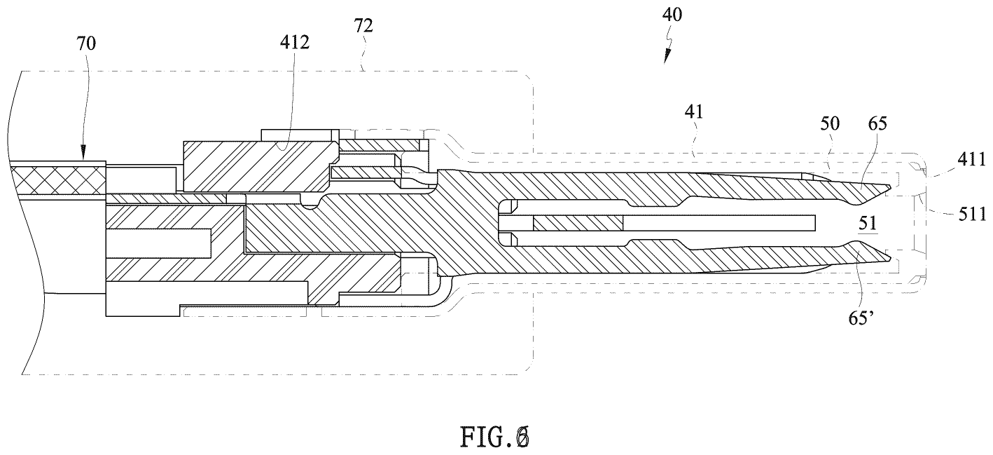

With reference to FIGS. 5 and 6, a high power DC charging plug connector 40 in accordance with the present invention is applied to insert into the high power DC charging socket connector 10 as shown in FIG. 1. The high power DC charging plug connector 40 has a third housing 41, an insulation bottom base 50, a single one first resilient positive board 60, a single one first resilient negative board 61, a single one second resilient positive board 62, and a single one second resilient negative board 63.

The third housing 41 is a metal housing and has a front opening 411 and a rear opening 412.

The insulation bottom base 50 is mounted in the third housing 41 and has an insertion recess 51 defined in the insulation bottom base 50 and facing the front opening 411 of the third housing 41. A mouth 511 of the insertion recess 51 corresponds to the insulation tongue 20 of the DC charging socket connector 10 in shape.

The first resilient positive board 60 and the first resilient negative board 61 are mounted on the insulation bottom base 50 side by side. A resilient portion 601, 611 is formed on each one of the first resilient positive board 60 and the first resilient negative board 61 and extends along a first recess wall 52 (upper wall) of the insertion recess 51. The second resilient positive board 62 and the second resilient negative board 63 are mounted on the insulation bottom base 50 side by side. A resilient portion 621, 621 is formed on each one of the second resilient positive board 62 and the second resilient negative board 63 and extends along a second recess wall 53 (lower wall) of the insertion recess 51. Viewed from a direction of FIG. 3, the first resilient positive board 60 and the second resilient positive board 62 are respectively located on an upper and a lower positions alternatively at left and right positions. The first resilient negative board 61 and the resilient second negative board 63 are respectively located on an upper and a lower positions alternatively at right and left positions. Therefore, the second resilient negative board 63 is located below the first resilient positive board 60, and the second resilient positive board 62 is located below the first resilient negative board 61.

Rear ends of the first resilient positive board 60, the first resilient negative board 61, the second resilient positive board 62, and the second resilient negative board 63 extend out of a rear end of the insulation bottom base 50 and protrude out of the rear opening 412 of the third housing 41 to be electrically connected with multiple metal wires 71 of a charging wire 70. In addition, the DC charging plug connector 40 may further comprise an outer rubber body 72 coating the charging wire 70 and a connection portion between the charging wire 70 and the third housing 41.

In an embodiment, the DC charging plug connector 40 may further has at least one second signal terminal 64 mounted on the insulation bottom base 50 and located between the first resilient positive board 60 and the first resilient negative board 61 or between the second resilient positive board 62 and the second resilient negative board 61. A rear end of each one of the at least one signal terminal 64 is integrally connected with the corresponding first resilient negative board 61 or the second resilient negative board 63. In one embodiment, the DC charging plug connector 40 has two second signal terminals 64 mounted between the first resilient positive board 60 and the first resilient negative board 61, and between the second resilient positive board 62 and the second resilient negative board 63, respectively.

In an embodiment, the DC charging plug connector 40 further comprises two third signal terminals mounted respectively on the first recess wall 52 and the second recess wall 53 of the insertion recess 51 in the insulation bottom base 50. The two third signal terminals are aligned with each other and located between the first resilient positive board 60 and the first resilient negative board 61, and between the second resilient positive board 62 and the second resilient negative board 63, respectively. As shown in FIG. 6, rears ends of the two third signal terminals are connected integrally with each other to form a tuning fork-shaped terminal.

When the DC charging plug connector 40 is inserted into the DC charging socket connector 10 from a direction of FIG. 5 along a direction of FIG. 1, as shown in FIGS. 3 and 4, the insulation tongue 20 of the DC charging socket connector 10 will extend into the insertion recess 51 in the insulation bottom base 50. At this time, the resilient portions 601, 611 of the first resilient positive board 60 and the first resilient negative board 61 will be in contact directly with the first positive board 30 and the first negative board 31 of the DC charging socket connector 10. The second signal terminal 64 integrally connected with the first resilient negative board 61 will be in contact with the first negative board 31. The third signal terminal 65 on the first recess wall 52 of the insertion recess 51 in the insulation bottom base 50 will be in contact with the first signal terminal 35 mounted on the first surface 21 of the insulation tongue 20. Simultaneously, the resilient portions 621, 631 of the second resilient positive board 62 and the second resilient negative board 63 will be in contact with the second positive board 32 and the second negative board 33 of the DC charging socket connector 10. The second signal terminal 64′ integrally connected with the second resilient negative board 63 contacts with the first signal terminal 35′ on the second surface 22 of the insulation tongue 20. In addition, as shown in FIG. 4, the contact portion 341 of the resilient terminal 34 of the DC charging socket connector 10 contacts with a top surface of the third housing 41 of the DC charging plug connector. 40.

The DC charging plug connector 40 can be turned upside down 180° and inserted into the DC charging socket connector 10, as shown in FIG. 3, so the DC charging plug connector in accordance with the present invention can be inserted into the DC charging socket connector 10 in any direction, a positive direction or a reversed direction.

Based on the foregoing description, the maximum current of the DC charging socket connector and the DC charging plug connector in accordance with the present invention can be increased to achieve the high power charging effect. A single positive board and a single negative board are mounted on the first surface of the insulation tongue of the DC charging socket connector, Only a first signal terminal is mounted between the first positive board and the first negative board, and no further terminal is arranged on the first surface. Therefore, the widths of the single positive board and the single negative board can be as large as possible with the connector size standards. For the same reason, the DC charging plug connector only has a single first resilient positive board, a single first resilient negative board, a single second resilient positive board, and a single second resilient negative board, so the width of each board can be as large as possible with the connector size standards. Accordingly, the maximum current can be effectively increased (taking the size specification of the USB TYPE-C connector as an example, the withstand current value of connector in accordance with the present invention can be increased to 20 A) to achieve the high power charging effect. In addition, because the width of each board of the DC charging socket connector is wider than that of a conventional connector of the same size, the structural strength of the insulation tongue can be enhanced to prolong the useful life of the DC charging plug connector in accordance with the present invention.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A high power direct-current charging socket connector comprising
a first housing;
an insulation tongue mounted in the first housing and has a first surface and a second surface opposite to each other;
a single first positive board mounted on the first surface of the insulation tongue;
a single first negative board mounted on the first surface of the insulation tongue and arranged with the first positive board side by side;
a single second positive board mounted on the second surface of the insulation tongue and located alternatively below the first negative board; and
a single second positive board mounted on the second surface of the insulation tongue and located alternatively below the first positive board.

2. The socket connector as claimed in claim 1 further comprising a first signal terminal mounted on the first surface of the insulation tongue and located between the first positive board and the first negative board.

3. The socket connector as claimed in claim 1 further comprising two first signal terminals mounted respectively on the first surface and the second surface of the insulation tongue, wherein
the first signal terminal mounted on the first surface is located between the first positive board and the first negative board; and
the first signal terminal mounted on the second surface is located between the second positive board and the second negative board.

4. The socket connector as claimed in claim 1 further comprising a resilient terminal mounted in the first housing and located above the first surface of the insulation tongue.

5. The socket connector as claimed in claim 2 further comprising a resilient terminal mounted in the first housing and located above the first surface of the insulation tongue.

6. The socket connector as claimed in claim 3 further comprising a resilient terminal mounted in the first housing and located above the first surface of the insulation tongue.

7. The socket connector as claimed in claim 4, wherein
the first housing comprises a front opening, a rear opening, and a first through hole;
an insulation base is formed integrally on a rear end of the insulation tongue and held in the rear opening of the first housing; and
the resilient terminal is mounted securely inside the insulation base and has a front end extending into the first through hole and bent to form a contact portion located in front of the insulation base.

8. The socket connector as claimed in claim 4, wherein a spacer plate is laterally embedded in the insulation tongue.

9. The socket connector as claimed in claim 8, wherein the spacer plate comprises
a body being a flat board;
two sides partially exposed respectively from two opposite sides of the insulation tongue, and each side having a thickness being same as or twice of a thickness of the body; and
a front end being non-flat and having a highest height larger than the thickness of the body.

10. The socket connector as claimed in claim 9, wherein the front end of the spacer plate partially or completely protrude out from a front end of the insulation tongue.

11. The socket connector as claimed in claim 10, wherein
a width of each one of the first negative board and the second negative board is wider than a wider of each one of the first positive board and the second positive board;
the thickness of the body of the spacer plate is smaller than 0.15 mm; and
each one of the first positive board, the first negative board, the second positive board, and the second negative board has a minimum thickness of 0.2 mm, and a gap with a maximum distance of 0.2 mm formed between the spacer plate and each one of the first positive board, the first negative board, the second positive board, and the second negative board.

12. The socket connector as claimed in claim 7 further comprising a second housing mounted around the first housing and having a second through hole communicating with the first through hole in the first housing.

13. A high power direct-current charging plug connector comprising:
a third housing having a front opening and a rear opening;
an insulation bottom base mounted in the third housing and comprising an insertion recess having a first recess wall, a second recess wall, and a mouth facing the front opening in the third housing;
a single one first resilient positive board mounted on the insulation bottom base and having a resilient portion extending along the first recess wall of the insertion recess;
a single one first resilient negative board mounted on the insulation bottom base, having a resilient portion extending along the first recess wall of the insertion recess, and arranged with the first resilient positive board side by side;
a single one second resilient positive board mounted on the insulation bottom base, having a resilient portion extending along the second recess wall of the insertion recess, located alternative below the first resilient positive board and below the first resilient negative board; and
a single one second resilient negative board mounted on the insulation bottom base, having a resilient portion extending along the second recess wall of the insertion recess, located alternatively below the first resilient negative board and below the first resilient positive board.

14. The plug connector as claimed in claim 13 further comprising at least one second signal terminal mounted on the insulation bottom base and located between the first resilient positive board and the first resilient negative board or between the second resilient positive board and the second resilient negative board, and a terminal end of each one of the at least one second signal terminal connected integrally with a corresponding first resilient negative board or a corresponding second resilient negative board.

15. The plug connector as claimed in claim 13 further comprising two second signal terminals respectively mounted between the first resilient positive board and the first resilient negative board and between the second resilient positive board and the second resilient negative board, and each one of the two second signal terminal has a terminal end connected integrally with a corresponding one of the first resilient negative board and the second resilient negative board.

16. The plug connector as claimed in claim 13 further comprising two third signal terminals mounted respectively on the first recess wall and the second recess wall of the insertion recess, aligned with each other, and located between the first resilient positive board and the first resilient negative board and between the second resilient positive board and the second resilient negative board, respectively.

17. The plug connector as claimed in claim 16, wherein rears ends of the two third signal terminals are connected integrally with each other to form a tuning fork-shaped terminal.

18. The plug connector as claimed in claim 13, wherein rear ends of the first resilient positive board, the first resilient negative board, the second resilient positive board, and the second resilient negative board extend out of a rear end of the insulation bottom base and protrude out of the rear opening of the third housing to be electrically connected with multiple metal wires of a charging wire.

19. The plug connector as claimed in claim 18 further comprising an outer rubber body coating the charging wire and a connection portion between the charging wire and the third housing.
